(19) United States
(12) Patent Application Publication
(10) Pub. No.: US 2025/0184387 A1
(43) Pub. Date: Jun. 5, 2025

(54) EFFICIENTLY DISTRIBUTING LARGE FILES IN MOBILE NETWORK

(71) Applicant: RAKUTEN MOBILE, INC., Tokyo (JP)

(72) Inventors: Yidao WANG, Tokyo (JP); Takatsugu ISHIKAWA, Tokyo (JP); Takashi KATAGIRI, Tokyo (JP)

(73) Assignee: RAKUTEN MOBILE, INC., Tokyo (JP)

(21) Appl. No.: 18/018,611

(22) PCT Filed: Sep. 29, 2022
(86) PCT No.: PCT/JP2022/036508

§ 371 Date: Jan. 16, 2025

(51) Int. Cl. H04L 67/06; H04L 41/12; H04L 43/06

(52) U.S. Cl. CPC H04L 67/06; H04L 41/12; H04L 43/06

(57) ABSTRACT

A communication network system includes multiple communication nodes and a control node, and has a topology including multiple rings in which the multiple communication nodes are connected in ring form. The communication network system includes a first management apparatus for the control node and a second management apparatus for each communication node. The first management apparatus, by one or more first processors, causes the control node to transmit the image file and a transmission command specifying transmission routes from the control node to the multiple destination nodes. The second management apparatus, by one or more second processors, performs the following operations. The second management apparatus causes a branching node to duplicate the received image file. The second management apparatus causes each communication node on the transmission routes to transmit the received image file to another communication node along the transmission routes in accordance with the transmission command.

### TECHNICAL FIELD

The present disclosure relates to improvement of the efficiency of transmission of large image files for generating virtual network functions.

In communication network systems, network service-providing environments, such as containers or virtual network functions (VNFs) necessary for providing services, are sometimes generated (also referred to as “expansion” or “deployment”).

Network service-providing environments are sometimes generated in facilities near users who are to be provided with the services, in accordance with the types of services. Network service-providing environments are generated by using file groups known as catalogs. These catalogs include files necessary for generating network service-providing environments, such as settings information and image files for generating containers.

### SUMMARY OF INVENTION

### Technical Problem

Catalogs include many files, among which image files have a particularly large file size, causing the sizes of the catalogs to be on the order of gigabytes or more. Additionally, since the settings differ for each network service, if many network services are to be provided, then many types of catalogs are necessary. However, small-scale facilities, such as GCs (group centers), in which network service-providing environments may be generated, are only lightly equipped, and therefore have difficulty storing so many large catalogs in advance (for preparation, even before a generation command is issued). Therefore, catalogs are stored at large-scale facilities that can store many large files, such as CDCs (central data centers). When generating a network service-providing environment, a catalog suitable for the network service is selected and transmitted from the large-scale facility to the generation site.

However, there are few large-scale facilities such as CDCs, and they are often located far from small-scale facilities such as GCs. For this reason, it can take time to transmit a catalog including large image files from a large-scale facility to a small-scale facility, and this also prolongs the time from when catalog transmission starts until the network service-providing environment is finished being generated.

Furthermore, when the same virtual environment is generated in multiple GCs, a CDC will often transmit catalogs including large image files to the multiple GCs simultaneously.

However, communication resources should preferably not be excessively used when transmitting catalogs for generating virtual environments.

The present disclosure relates to shortening the time required for catalog transmission by efficiently transmitting, to multiple GCs, catalogs including large image files for generating virtual environments.

### Solution to Problem

A communication network system disclosed herein includes multiple communication nodes and a control node in which an image file is saved.

The communication network system has a topology including multiple rings in which the multiple communication nodes are connected in ring form. The communication network system includes a first management apparatus for the control node and a second management apparatus for each communication node.

The first management apparatus includes one or more first processors. At least one of the one or more first processors transmits a transmission command for transmitting an image file to multiple destination nodes among the multiple communication modes. The transmission command specifies transmission routes from the control node to the multiple destination nodes.

At least one of the one or more first processors further causes the control node to transmit the image file for the multiple destination nodes.

The second management apparatus includes one or more second processors. At least one of the one or more second processors causes a branching node, at which the transmission routes branch, to duplicate the received image file in accordance with the transmission command.

At least one of the one or more second processors causes each communication node on the transmission routes to transmit the received image file to another communication node along the transmission routes in accordance with the transmission command.

A second management apparatus disclosed herein is provided for each communication node in a communication network system. The communication network system includes multiple communication nodes and a control node in which an image file is saved.

The communication network system has a topology including multiple rings in which the multiple communication nodes are connected in ring form.

The second management apparatus includes one or more second processors. When the control node transmits the image file for multiple destination nodes among the multiple communication nodes, at least one of the one or more second processors execute the operations indicated below.

At least one of the one or more second processors causes a branching node, at which the transmission routes branch, to duplicate the received image file in accordance with a transmission command specifying transmission routes from the control node to the multiple destination nodes.

At least one of the one or more second processors causes each communication node on the transmission routes to transmit the received image file to another communication node along the transmission routes in accordance with the transmission command.

A method disclosed herein is a method for transmitting an image file from a control node to multiple destination nodes among multiple communication nodes in a communication network system including the multiple communication nodes and the control node in which the image file is saved.

The communication network system has a topology including multiple rings in which the multiple communication nodes are connected in ring form.

The method includes determining transmission routes from the control node to the multiple destination nodes.

The method includes causing the control node to transmit the image file for the multiple destination nodes.

The method includes causing a branching node at which the transmission routes branch, among the communication nodes on the transmission routes, to duplicate the received image file.

The method includes causing each communication node on the transmission routes to transmit the received image file to another communication node along the transmission routes.

### BRIEF DESCRIPTION OF DRAWINGS

FIG. 1 is a schematic diagram illustrating an existing embodiment.

FIG. 2 is a diagram for explaining an example of connections between a CDC, RDCs and GCs.

FIG. 3 is a diagram for explaining an example of image file transmission according to the present embodiment.

FIG. 4 is an example of a transmission command for performing the image file transmission indicated in FIG. 3.

FIG. 5 is a functional block diagram of a first management apparatus according to the present embodiment.

FIG. 6 is a functional block diagram of a second management apparatus according to the present embodiment.

FIG. 7 is a diagram for explaining an example, different from that in FIG. 3, of image file transmission according to the present embodiment.

FIG. 8 is a diagram for explaining retransmission in response to the image file transmission indicated in FIG. 7.

FIG. 9 is an example of a retransmission command for performing the retransmission indicated in FIG. 8.

FIG. 10 is a flow chart indicating an example of an image file transmission method according to the present embodiment.

FIG. 11 is a block diagram illustrating the configuration of the first management apparatus illustrated in FIG. 5.

FIG. 12 is a block diagram illustrating the configuration of the second management apparatus illustrated in FIG. 6.

### DESCRIPTION OF EMBODIMENTS

Hereinafter, an embodiment in the present disclosure will be explained in detail by referring to the drawings.

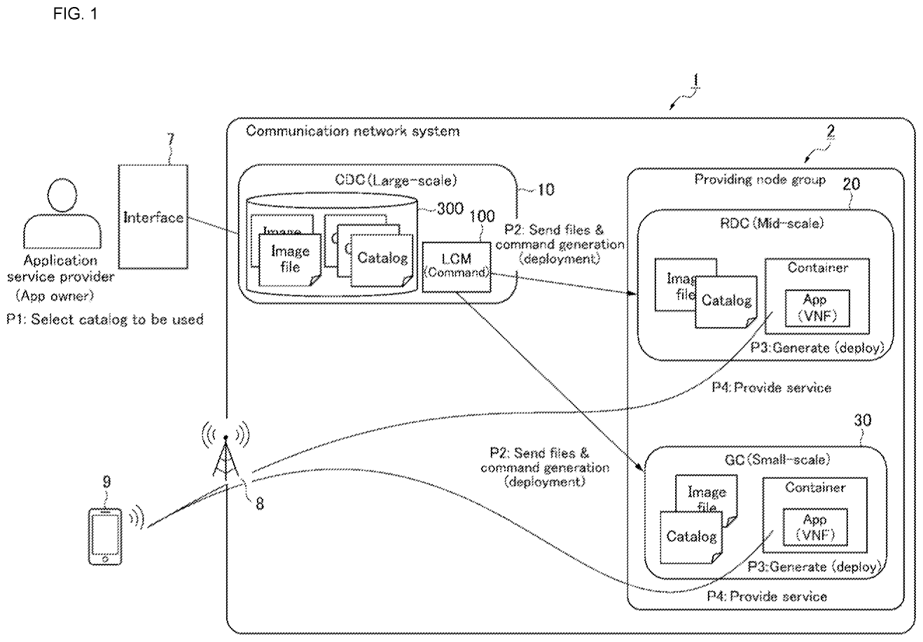

FIG. 1 is a schematic diagram illustrating an existing embodiment. FIG. 1 illustrates a communication network system 1. It is assumed that the communication network system 1 is communicating with the information processing apparatus 9.

The information processing apparatus 9 may be a mobile apparatus, such as a smartphone, or may be a stationary apparatus.

FIG. 1 illustrates a base station 8. This indicates that, if the information processing apparatus 9 is a mobile apparatus, then the information processing apparatus 9 communicatively connects with the communication network system 1 via the base station 8, which transmits radio waves for wireless communication. However, the communication between the information processing apparatus 9 and the communication network system 1 may be wired communication, and in that case, the base station 8 may be absent.

The communication network system 1 is constituted by communication systems constructed in multiple communication facilities. In the present description, the communication systems in the communication facilities will also be described as communication nodes. Additionally, in the present description, for convenience of explanation, the names of communication facilities such as CDCs, RDCs, and GCs may also refer to communication nodes, i.e., to the communication systems constructed in those communication facilities. For example, the communication network system 1 includes a CDC 10 as one of the communication nodes.

The CDC 10 accommodates functions for implementing control, etc. of the communication network system 1, such as an orchestrator (not illustrated). For this reason, the CDC 10 can be considered to be a node (control node) that handles control among the communication nodes constituting the communication network system 1.

The CDC 10 is a large-scale facility (e.g., a central data center). Such large-scale facilities are assumed to exist at only a few locations in a wide area. For example, there may be just a few in an area such as a country or a large province. For example, in Japan, the country can be divided into two sections, i.e., eastern Japan and western Japan, and a single CDC 10 may be located in each section.

The orchestrator is a system that handles the execution, management, repair, or the like of functions executed by the communication network system 1, such as network slices.

The orchestrator contains a life cycle manager (LCM) 100. The LCM 100 manages applications such as virtual network functions (VNFs). The LCM 100 may be a single apparatus or may be a system constituted by multiple apparatuses.

Applications such as virtual network functions (VNFs) are used for realizing network services provided by the communication network system 1 to the information processing apparatus 9. In order to construct an application, a file group known as a catalog (also called a catalog file or a bundle catalog) is used. The catalog includes settings information for the application, and may be saved in storage (also called a container registry) 300 in the CDC 10 or may held by the orchestrator.

For example, generally, in order to generate a VNF and a virtual environment for realizing the VNF, image files for generating the virtual environment, such as a container (image files for generating a container are also called container images, Docker images being an example thereof), are used. Image files are one type of file group known as a catalog.

The file sizes of the image files are on the order of gigabytes. If files of this size are transmitted to multiple virtual environment construction sites without thinking, the resources in the communication network will be strained.

Hereinafter, the transmission of exclusively image files will be described. However, the present disclosure is not limited to image files, and the efficiency of transmission of more general files can be improved. In other words, the image files may be reworded as other types of files, and the efficient transmission of general files is within the scope of the present disclosure.

The communication network system 1 includes a providing node group 2 constituted by one or more providing nodes. A providing node refers to a server or a system in which an application for providing various services to the information processing apparatus 9 via the communication network system 1 can be deployed. More specifically, each providing node can construct a virtual environment such as a container, and an application can be deployed as a VNF on the virtual environment. In other words, a VNF for realizing an application is generated in a virtual environment on each providing node. Hereinafter, the virtual environments in which the VNFs for realizing applications are generated will be called network service-providing environments.

The respective providing nodes in the providing node group 2 may be independent of each other. That is, one or more providing nodes in the providing node group 2 may be managed by vendors different from the communication network system 1. Additionally, the providing nodes managed by vendors different from that of the communication network system 1 may be located outside the communication network system 1.

In FIG. 1, the providing nodes in the providing node group 2 are accommodated in RDCs 20 or GCs 30. Although FIG. 1 illustrates one RDC and GC each, there is no particular restriction on the number of RDCs and GCs in the communication network system 1.

The RDCs 20 are mid-scale facilities (e.g., regional data centers) that are located, for example, at the regional level, such as in each prefecture.

The GCs 30 are small-scale facilities (e.g., facilities corresponding to base station groups) that are directly connected to respective base stations and that are located near users utilizing communication services.

Additionally, FIG. 1 illustrates an interface 7. This indicates that an application service provider that has generated an application in a providing node and that is to provide a service by means of the application may, via the interface 7, request the communication network system 1 to generate an application.

Referring to FIG. 1, an application deployment procedure will be briefly explained.

First, the application service provider selects, via the interface 7 of the communication network system 1, a catalog to be used to generate an application, based on the functions, etc. of the application (see reference sign P1).

The LCM 100 selects, from the providing node group 2, one providing node that constructs the network service-providing environment based on the selected catalog and the available resources, etc. in each providing node. Hereinafter, the selected providing node (i.e., the application execution environment) will be referred to as the “deployment site”. As the deployment site, a providing node in an RDC 20 or a providing node in a GC 30 may be selected. Furthermore, the facility (RDC 20 or GC 30) itself in which the providing node that is the deployment site is located will also sometimes be called the “deployment site”.

FIG. 1 illustrates both the case in which the deployment site is an RDC 20 and the case in which the deployment site is a GC 30. The deployment site may be determined, as appropriate, in accordance with specifications requested by the provided service or the environment at the deployment site.

Furthermore, the LCM 100 transmits, to the deployment site, the catalog and the image files used to generate the network service-providing environment for realizing the application. Furthermore, the LCM 100 commands the generation of the network service-providing environment (see reference sign P2).

The deployment site deploys a VNF in accordance with a request. That is, a VNF is generated in a container at the deployment site (see reference sign P3).

The user who is to utilize the network service, upon accessing the communication network system 1 by means of the information processing apparatus 9, is connected to the VNF at the deployment site and receives the network service. That is, the generated VNF provides the service (see reference sign P4).

In the existing embodiment illustrated in FIG. 1, a catalog and image files are transmitted from the CDC to a deployment site (a providing node in a GC or an RDC) (see reference sign P2). In this case, time is required for the catalog and the image files to be downloaded from the CDC by the deployment site. Thus, the time from when the transmission of the catalog and the image files starts until the generation of the network service-providing environment is finished also become long.

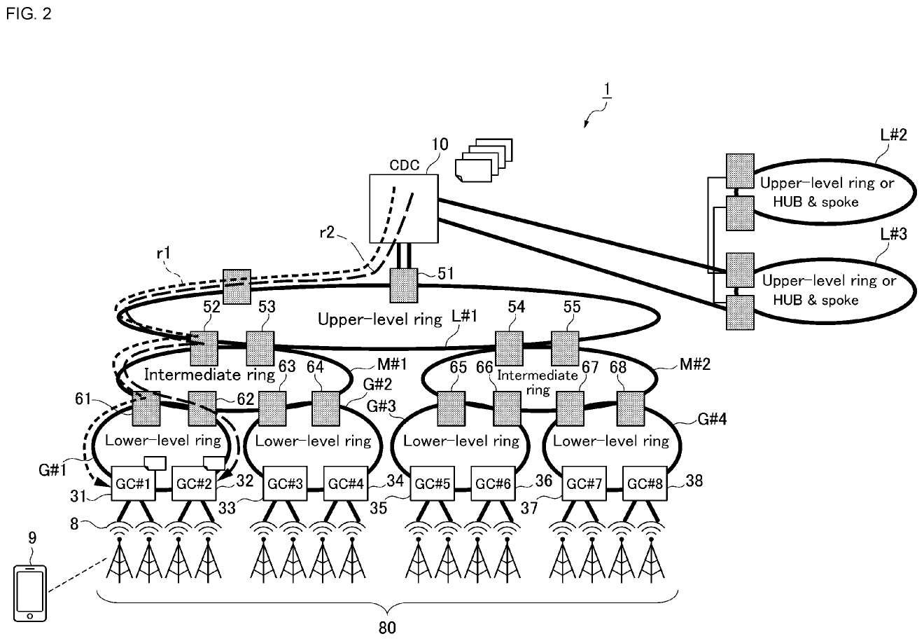

Next, an example of connections between the CDC, the RDCs and the GCs in a communication network system in which the apparatus or the method disclosed herein is provided will be explained in detail with reference to FIG. 2.

FIG. 2 illustrates, in a communication network system 1, a CDC 10, eight GCs from GC #1 to GC #8 (see reference signs 31 to 38), and a base station group 80 including one or more base stations. Though omitted in FIG. 2, the communication network system 1 may include one or more RDCs, and these RDCs may, for example, be intermediate rings as mentioned below.

FIG. 2 further illustrates boundary nodes (see reference signs 51 to 55 and reference signs 61 to 68).

FIG. 2 illustrates that the communication network system 1 is constituted by multiple ring networks that connect communication nodes (equipment), such as RDCs and GCs, in the form of rings.

In the example in FIG. 2, the communication network system 1 is assumed to include an upper-level ring, intermediate rings, and lower-level rings. The upper-level ring is the uppermost ring network that includes the CDC. The lower-level rings are the lowest rings connecting the GCs in the form of rings. The intermediate rings are ring networks located intermediately between the upper-level ring and the lower-level rings. RDCs may be located in the intermediate rings.

The upper-level ring, the intermediate rings, and the lower-level rings can communicate with the other ring networks by sharing one or more communication nodes with other ring networks. The shared communication nodes will be called boundary nodes. The RDCs or the GCs may also serve as boundary nodes.

More specifically, in FIG. 2, the CDC 10 is communicably connected to one or more upper-level rings (see L #1, L #2, and L #3) via boundary nodes (e.g., the boundary node 51 that is a relay between the CDC 10 and L #1). Each upper-level ring is communicably connected to one or more boundary nodes. For example, L #1 is further connected to four boundary nodes (reference signs 52 to 55) in ring form.

Each upper-level ring is communicably connected to one or more intermediate rings (see M #1 and M #2) via boundary nodes. For example, L #1 is connected to M #1 via two boundary nodes (reference signs 52, 53). L #1 is further connected to M #2 via two boundary nodes (reference signs 54, 55).

Each intermediate ring is communicably connected to one or more boundary nodes. Each intermediate ring can further communicably connect with one or more RDCs. For example, M #1 connects six boundary nodes (reference signs 52, 53, 61, 62, 63, 64) in ring form. M #2 connects six boundary nodes (reference signs 54, 55, 65, 66, 67, 68) in ring form.

As mentioned above, M #1 and M #2 each may further include one or more RDCs. For example, if there were an RDC between the boundary node 53 and the boundary node 62 in M #1, then M #1 would connect the six boundary nodes (reference signs 52, 53, 61, 62, 63, 64) and the RDC in ring form.

Alternatively, since RDCs or GCs may also serve as boundary nodes, for example, the boundary node 62 may be an RDC. In that case, M #1 includes an RDC.

Each intermediate ring can further communicably connect with lower-level rings (see G #1 to G #4) via boundary nodes. For example, M #1 is connected with G #1 via two boundary nodes (reference signs 61, 62). M #1 is further connected to G #2 via two boundary nodes (reference signs 63, 64).

Each lower-level ring communicably connects one or more boundary nodes with one or more GCs. For example, G #1 connects the two boundary nodes (reference signs 61, 62) with GC #1 and GC #2 in ring form. Each GC can communicably connect with a base station.

In FIG. 2, one or more base stations that reach the CDC 10 via L #1 are illustrated as the base station group 80.

Although FIG. 2 illustrates three upper-level rings, two intermediate rings, and four lower-level rings, the numbers of these rings, the number of nodes, and the connection mode are not limited in any way.

Additionally, although FIG. 2 illustrates the case in which the deployment sites are GCs, as explained with reference to FIG. 1, the deployment sites are not limited to being GCs, and may be RDCs.

The routes by which image files are downloaded to the GCs that are the deployment sites illustrated as an example in FIG. 2 will be explained. As mentioned above, the image files are saved in storage in the CDC 10.

The route for the case in which the image files are downloaded from the storage in the CDC 10 to GC #1 is a route r1 from the CDC 10 to GC #1 through the boundary nodes 51, 52, and 61.

The route for the case in which the image files are downloaded from the storage in the CDC 10 to GC #2 is a route r2 from the CDC 10 to GC #2 through the boundary nodes 51, 52, 61, and 62.

For this reason, when the same virtual environment is generated in GC #1 and GC #2, large image files are transmitted from the CDC 10 to GC #1 and GC #2, respectively, through routes r1 and r2. Furthermore, these communication often occurs at the same time. For this reason, the communication resources are heavily burdened in the communication network system 1, particularly in the portion from the CDC 10, through the boundary nodes 51 and 52, and to the boundary node 61, where the r1 and r2 overlap.

Therefore, in an embodiment disclosed herein, regarding the transmission of image files from the CDC 10 to the deployment sites, a first management apparatus and a second management apparatus are established for controlling the transmission of the same image files to multiple deployment sites.

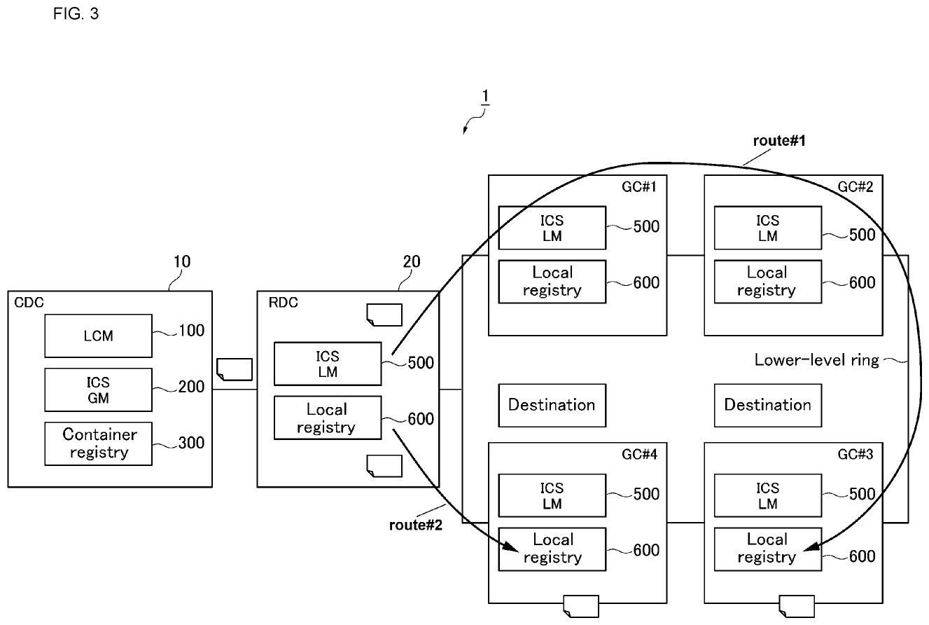

A first management apparatus (also called an Image Caching Service General Manager (ICS GM)) manages the transmission of image files from the CDC 10. As mentioned above, the CDC 10 is an example of a control node, and the CDC 10 may be reworded as a control node that saves image files in storage (e.g., the container registry 300 in FIG. 3), etc. therein.

A second management apparatus (also called an Image Caching Service Local Manager (ICS LM)) manages the transmission and reception of image files at respective communication nodes other than the control node (CDC 10).

In this case, the first management apparatus (ICS GM) is established in the CDC 10 and second management apparatuses (ICS GMs) are established in each of the communication nodes. The installation location of the first management apparatus is not limited to being in the CDC 10.

FIG. 3 is a diagram for explaining an example of image file transmission according to the present embodiment. FIG. 3 illustrates, for convenience of explanation, the CDC 10, an RDC 20, and one lower-level ring, which is a portion of the communication network system 1 illustrated in FIG. 2. Additionally, for convenience of explanation, the lower-level ring includes four GCs (GC #1 to GC #4). In FIG. 3, the portions that are the same as those in FIG. 1 are assigned the same reference signs.

As illustrated in FIG. 3, the CDC 10 is provided with the aforementioned first management apparatus (ICS GM) 200 in addition to the LCM 100 and the storage (container registry) 300. The first management apparatus 200 may also be outside the CDC 10.

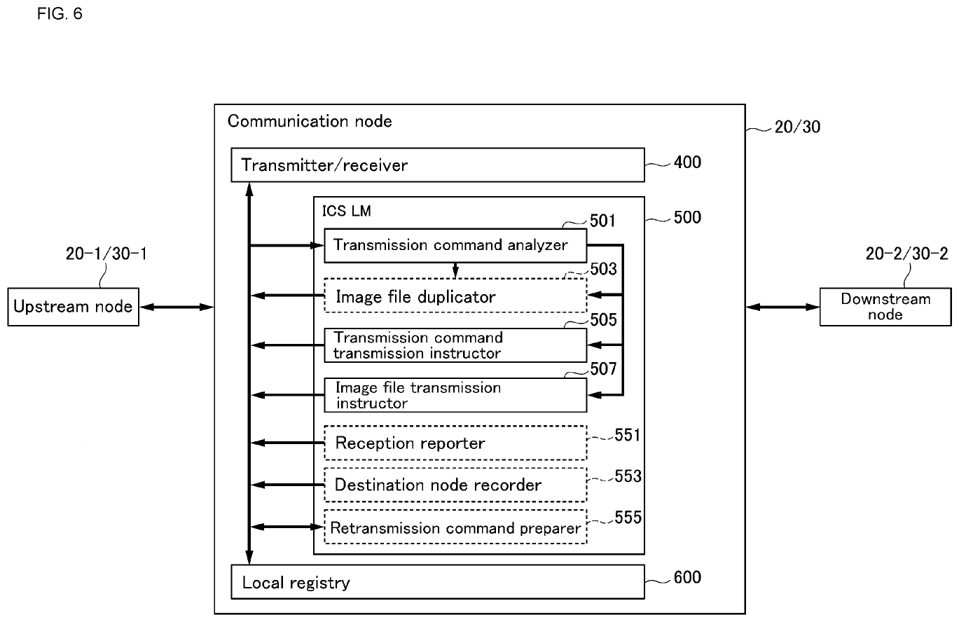

Additionally, the communication nodes (i.e., the RDC 20 and GC #1 to GC #4) are each provided with a transmitter/receiver (reference sign 400 in FIG. 6) for transmitting and receiving image files and transmission commands, the aforementioned second management apparatus (ICS LM) 500, and storage (local registry) 600 in which image files, etc. can be saved.

Hereinafter, the operations in the first management apparatus 200 and the second management apparatus 500 when VNF deployment is requested according to the present embodiment will be explained with reference to FIG. 3.

The first management apparatus 200 recognizes the topology of the communication network system 1, and when the nodes that are the destinations (also referred to as “destination nodes”) are designated, determines transmission routes for the image file to be transmitted. The first management apparatus 200 prepares a transmission command to be directed to the communication nodes based on the determined transmission routes. That is, the transmission command specifies at least transmission routes.

The first management apparatus 200 causes the CDC 10 to transmit the image file from the CDC 10 to the communication network system 1, more specifically to the RDC 20, which is a communication node adjacent to the CDC 10 on the communication routes. The transmission command may be transmitted together with the image file. Alternatively, the transmission command may be transmitted to each communication server on the transmission route before the image file is transmitted. In particular, the transmission command may be multi-cast from the CDC 10 towards multiple communication nodes on the route.

The following rules apply to the transmission of the image file.

(1) Even if multiple destination nodes are designated, if some of the transmission routes to the respective destination nodes overlap, then the CDC 10 transmits a single image file. For example, when all of the multiple destination nodes lie beyond the same upper-level ring, a single image file is transmitted just once from the CDC 10.

(2) In communication nodes (also called “branching nodes” or “duplicating nodes”) at which the transmission route branches to multiple destination nodes, the image file is duplicated. In particular, the image file in the storage 600 is duplicated by the second management apparatus 500 in a branching node. As a result thereof, one image file can be transmitted to each of the branched transmission routes.

(3) Each communication node that has received the image file transmits the image file to another adjacent communication node along the transmission route. When each communication node that has received the image file transmits the image file to the other adjacent communication node, that communication node may transfer the image file to the other adjacent communication node without saving the image file.

In FIG. 3, the destination nodes are GC #3 and GC #4. Since these can be considered to lie beyond the same upper-level ring, just a single image file is transmitted from the CDC 10 to GC #3 and GC #4 by the first management apparatus 200.

Furthermore, in the RDC 20, the route branches into a route to GC #3 (referred to as route #1) and a route to GC #4 (referred to as route #2). That is, route #1 goes from the CDC 10, through the RDC 20, GC #1, and GC #2, to GC #3. In comparison therewith, route #2 is the same as route #1 from the CDC 10 to the RDC 20, but branches away from route #1 at the RDC 20 and goes to GC #4.

For this reason, the RDC 20 is a branching node at which the route branches into route #1 and route #2. Thus, the image file is duplicated in the RDC 20, with one image file passing through GC #1 and GC #2 to GC #3, and the other image file going to GC #4.

In conventional image file transmission methods, image files were transmitted separately from the CDC 10 (control node) to each of multiple destination nodes. For this reason, particularly at portions where the routes from the CDC 10 to multiple destination nodes overlap (portions between the CDC 10 and the RDC 20), there was a heavy burden on the communication network system due to overlapping transmission of the same image file.

In contrast therewith, according to the image file transmission of the present embodiment, only one image file is sent from the CDC 10 in the portion where the routes to multiple destination nodes overlap (from the CDC 10 to the RDC 20). Thus, the burden on the communication network system can be suppressed and efficient image file transmission becomes possible.

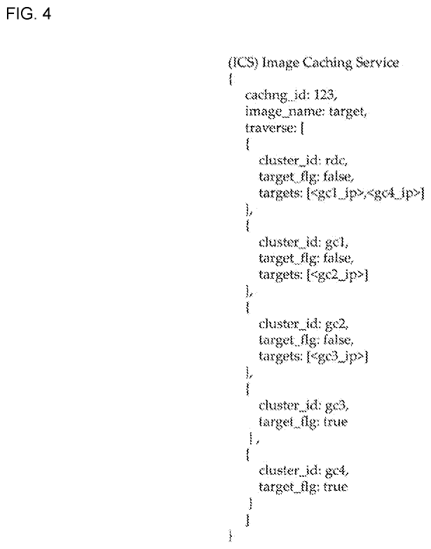

FIG. 4 indicates an example of a transmission command transmitted from the CDC 10 by the first management apparatus 200. This transmission command is an Image Caching Service (ICS) as designated in the caching_id (in this example, “123”) field. The image file to be transmitted is designated by the file name (in this example, “target”) in the image_name field.

The transmission route is designated in the traverse field.

With “RDC” as the communication node (cluster_id), the RDC is not a destination node, and the image file is transmitted to two destinations, i.e., GC #1 and GC #4. The target_flg field, which indicates whether or not the node is a destination node, indicates “false”. Additionally, the two destinations, GC #1 and GC #4, are designated, for example, by IP addresses (respectively gc1_ip and gc4_ip).

With “GC #1” as the communication node (cluster_id), the image file is transmitted to the GC #2. The target_flg field indicates “false”, and the destination GC #2 is designated, for example, by an IP address (gc2_ip).

With “GC #2” as the communication node (cluster_id), the image file is transmitted to the GC #3. The target_flg field indicates “false”, and the destination GC #3 is designated, for example, by an IP address (gc3_ip).

With “GC #3” and “GC #4” as the communication nodes (cluster_id), the target_flg field, which indicates whether or not the node is a destination node, becomes “true”.

This transmission route “traverse” designates the transmission destination of the image file in each communication node. Additionally, note that, in each communication node, the transmission destination of the image file is limited to an adjacent communication node. According to this transmission command, each communication node can execute image file transmission by means of IP addresses or the like, as long as the adjacent communication nodes are recognized.

Furthermore, the transmission route “traverse” indicates that, in the RDC, the image file is transmitted to two transmission destinations. That is, the RDC is a branching node at which the transmission routes branch, and thus, the image file is duplicated.

Thus, the “Image Caching Service” in FIG. 4 specifies a transmission route to multiple destination nodes, and is an example of a transmission command for the image file transmission in FIG. 3.

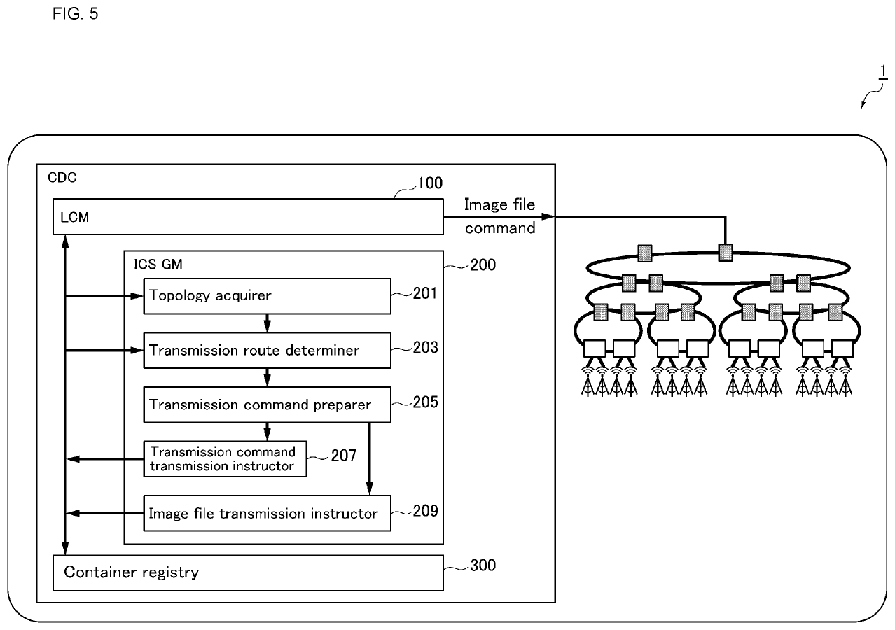

FIG. 5 is a functional block diagram illustrating the structure of the first management apparatus (ICS GM) 200 according to the present embodiment.

In FIG. 5, the first management apparatus 200 accommodated in the CDC 10 controls the transmission of an image file by the LCM 100. As mentioned above, the image file may be transmitted together with a transmission command. Alternatively, the transmission command may be transmitted to each communication server on the transmission routes before the image file is transmitted.

As mentioned above, the CDC 10 is a control node accommodating the storage (container registry) 300 in which catalogs and image files are saved.

Additionally, the communication network system 1 has a ring configuration, as explained by FIG. 2, and multiple GCs, which are destination nodes, are located beyond the same upper-level ring.

The structure of the first management apparatus 200 will be explained with reference to FIG. 5. The first management apparatus 200 is provided with a topology acquirer 201, a transmission route determiner 203, a transmission command preparer 205, a transmission command transmission instructor 207, and an image file transmission instructor 209.

The topology acquirer 201 acquires the connection mode (topology) between communication nodes in the communication network system 1. The topology acquirer 201 may periodically acquire and store the topology of the communication network system 1. The topology may be acquired through the orchestrator.

The transmission route determiner 203 determines transmission routes to image file destinations (deployment site communication nodes) based on the topology provided by the topology acquirer 201. The transmission route to each destination node need not be the shortest route, and the transmission routes may be determined so as to overlap as much as possible.

The transmission command preparer 205 prepares a transmission command for transmitting the image file via the transmission routes determined by the transmission route determiner 203. This transmission command may be one such as that indicated as an example in FIG. 4. When preparing the transmission command, the IP address of each communication node on the transmission routes may be acquired through the orchestrator. The IP addresses of the respective communication nodes on the transmission routes may be acquired by the topology acquirer 201 and these may be used.

The transmission command transmission instructor 207 may instruct that the transmission command prepared by the transmission command preparer 205 is to be transmitted, together with the image file, to each of the communication nodes on the transmission routes in the communication network system 1. Alternatively, it may be transmitted to each communication node on the transmission routes before the image file is transmitted.

The image file transmission instructor 209 designates the image file to be transmitted in the container registry 300 and instructs the communication network system 1 to transmit the image file.

FIG. 6 is a functional block diagram illustrating the structure of a second management apparatus (ICS LM) 500 according to the present embodiment.

In FIG. 5, a second management apparatus 500 accommodated in a communication node (an RDC 20 or a GC 30, hereinafter referred to as a communication node 20/30) controls the transmission of the image file by the transmitter/receiver 400. As mentioned above, a transmission command may be appended to the image file, or the image file and the transmission command may be transmitted separately. The communication node 20/30 accommodates storage (local registry) 600 for storing, temporarily or long-term, catalogs and image files.

Additionally, on a transmission route, the communication node 20/30 is adjacent to a communication node on the upstream side (an RDC 20-1 or a GC 30-1, hereinafter referred to as an upstream node 20-1/30-1) and is adjacent to a communication node on the downstream side (an RDC 20-2 or a GC 30-2, hereinafter referred to as a downstream node 20-2/30-2).

That is, the image file is transmitted from the upstream node 20-1/30-1 to the communication node 20/30. The transmitted image file is placed in the local registry 600.

The image file is further transmitted from the communication node 20/30 to the downstream node 20-2/30-2. Since the transmission routes may branch, the downstream node 20-2/30-2 may refer to two communication nodes.

When the communication node 20/30 is adjacent to the CDC 10 on the communication route, the upstream node is the CDC 10. Additionally, when the communication node 20/30 is a destination node on the communication route, there is no downstream node. Even in these cases, the explanation below applies, mutatis mutandis.

The structure of the second management apparatus 500 will be explained with reference to FIG. 6. The second management apparatus 500 is provided with a transmission command analyzer 501 and an image file transmission instructor 507.

The second management apparatus 500 may further include an image file duplicator 503. In particular, the second management apparatus 500 for a communication node 20/30 at which the transmission routes might branch includes an image file duplicator 503.

The second management apparatus 500 may include a transmission command transmission instructor 505.

The second management apparatus 500 may further include a reception reporter 551, a destination node recorder 553, and a retransmission command preparer 555. These will be explained below.

The transmission command analyzer 501 analyzes transmission commands. In particular, among transmission commands, it finds transmission commands for the communication node 20/30 and acquires information regarding the downstream node 20-2/30-2 to which the received image file is to be further transmitted.

When the analysis by the transmission command analyzer 501 determines that the transmission routes branch at the communication node 20/30, i.e., that there are two downstream nodes 20-2/30-2 (e.g., see the portion where the cluster_id is “rdc” in FIG. 4), the image file duplicator 503 duplicates the image file for each of the downstream nodes 20-2/30-2. The image file duplicator 503 may instruct the local registry 600 to duplicate the image file.

The transmission command transmission instructor 505 instructs that the transmission command received from the upstream node 20-1/30-1 should be transmitted to the downstream node 20-2/30-2. The transmission command transmission instructor 505 may instruct the transmitter/receiver 400 or the local registry 600 to transmit the transmission command.

If the CDC 10 multi-casts the transmission command to multiple communication nodes, then the transmission command transmission instructor 505 may be omitted. Additionally, the transmission command may be transmitted together with the image file or may be transmitted before the image file is transmitted.

The image file transmission instructor 507 instructs that the image file received from the upstream node 20-1/30-1 should be transmitted to the downstream node 20-2/30-2. The image file transmission instructor 507 may instruct the transmitter/receiver 400 or the local registry 600 to transmit the image file.

According to the first management apparatus explained by FIG. 5 and the second management apparatus explained by FIG. 6, the burden on the communication network system associated with redundant transmission of the same image file can be suppressed, and efficient image file transmission is made possible. In particular, efficient image file transmission is made possible at portions where transmission routes from a control node (CDC 10) to multiple destination nodes overlap.

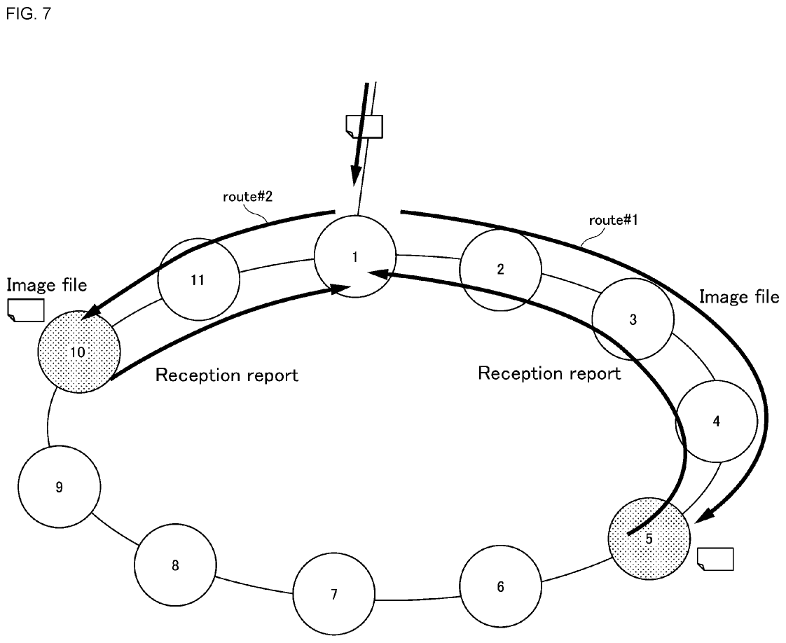

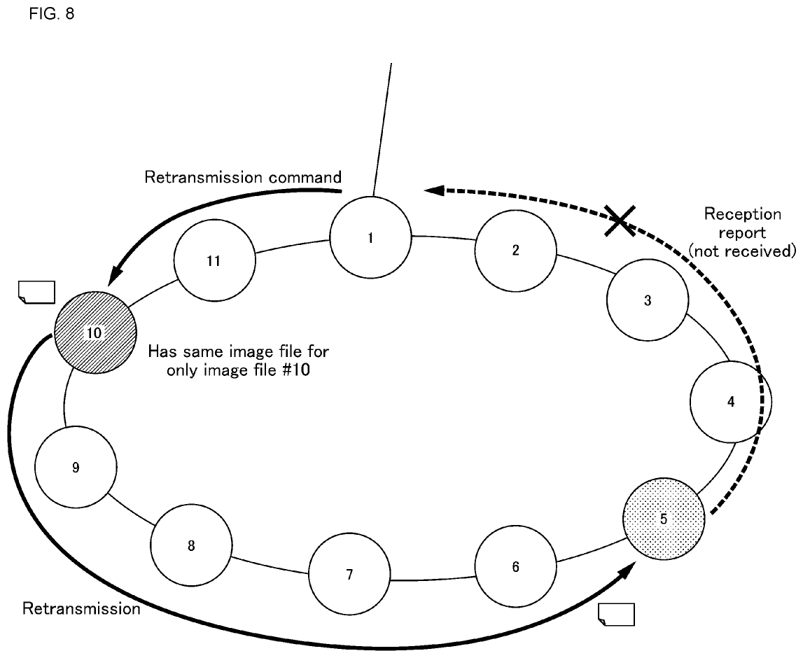

Furthermore, according to the image file transmission disclosed herein, the efficiency can also be improved for retransmission in the case in which a transmitted image file has failed to reach a destination node due to an obstacle or the like. Next, retransmission according to an embodiment will be explained with reference to FIG. 7 and FIG. 8.

FIG. 7 is a diagram for explaining an example different from FIG. 3 regarding image file transmission according to the present embodiment.

In FIG. 7, the circled numerals represent communication nodes, i.e., RDCs or GCs. Additionally, the circled numerals are numbers for distinguishing between communication nodes. In this case, the eleven communication nodes are referred to as Node #1 to Node #11 without distinguishing between RDCs and GCs. That is, FIG. 7 illustrates that the eleven communication nodes from Node #1 to Node #11 are connected in ring form.

The destinations of the transmitted image file are Node #5 and Node #10. Route #1 to Node #5 and route #2 to Node #10 branch at Node #1. Thus, Node #1 is a branching node that duplicates the image file. Route #1 goes from Node #1 to Node #2, Node #3, and Node #4 to Node #5. Route #2 goes from Node #1 through Node #11 to Node #10.

In this case, in order to allow the branching node to recognize the destination nodes, information for specifying the destination nodes is recorded in the second management apparatus (LCS LM) in the branching node. Furthermore, upon receiving the target image file, the destination nodes transmit reception reports to the branching node.

In some cases, there are two or more branching nodes on the transmission routes, and there is a second branching node downstream from the first branching node on the transmission routes (however, there are no further branching nodes between the first branching node and the second branching node on the transmission routes). In such cases, in the first branching node, the second branching node is identified as a destination node for reception, and information for specifying the second branching node is recorded. Additionally, when the second branching node receives the target image file, the first branching node is identified as a destination node, and a reception report is transmitted to the first branching node. Note that, due to these settings, the explanation below is still applicable even to cases in which there are two or more branching nodes.

Additionally, in conventional image file transmission methods, reception reports are made from multiple destination nodes to the CDC. However, in the present embodiment, reception reports need not be made from multiple destination nodes to the CDC.

The branching node transmits the image file to a destination node (referred to as a “first destination node”) located beyond the transmission route of one branch and to a destination node (referred to as “second destination node”) located beyond the transmission route of the other branch. If a reception report is received from the first destination node within a certain time after the image file is transmitted, then the branching node recognizes that the image file has arrived at the first destination node. However, if a reception report is not received from the second destination node within a certain time from the image file transmission, then the branching node recognizes that there is a possibility that the image file failed to reach the second destination node. In that case, the image file can be retransmitted to the second destination node.

In the example in FIG. 7, Node #1 recognizes that the destination nodes are Node #5 and Node #10.

Furthermore, Node #5 and Node #10 make reception reports to Node #1. Therefore, if a reception report is not received within a predetermined time after image file transmission from at least one of Node #5 or Node #10, then Node #1, which is a branching node, can recognize that there is a possibility that the image file failed to reach a destination node.

In the file transmission according to the present embodiment, if the branching node has recognized the arrival of the image file at the first destination node but has recognized that there is a possibility that the image file has failed to reach the second destination node, then the branching node may retransmit the image file to the second destination node, or the branching node may command the first destination node to transmit the image file to the second destination node.

Furthermore, this retransmission command may be for transmitting the image file from the first destination node towards the second destination node in the direction opposite to the direction towards the branching node as viewed from the first destination node. That is, the transmission route of the image file from the first destination node to the second destination node may be set so as not to overlap with the transmission route by which the branching node transmitted the image file to the second destination node. As a result thereof, cases in which a problem has occurred on the communication route between the branching node and the second destination node can be handled.

FIG. 8 is a diagram for explaining an example of retransmission in response to the image file transmission indicated in FIG. 7.

The branching node (Node #1) has received a reception report from the first destination node (Node #10) but has not received a reception report from the second destination node (Node #5) within a certain time after image file transmission.

Therefore, Node #1 transmits, to Node #10, a retransmission command for retransmitting the image file from Node #10 to Node #5.

Furthermore, this retransmission command may be for transmitting the image file from the first destination node (Node #10) towards the second destination node (Node #5) in the direction opposite to the direction towards the branching node (Node #1) as seen from the first destination node (Node #10).

Since the direction from Node #10 to Node #1 is clockwise, the retransmission to Node #5 may be performed in the counterclockwise direction from Node #10. That is, the image file may be retransmitted from Node #10, through Node #9, Node #8, Node #7, and Node #6 to Node #5.

With the image file transmission according to the present embodiment, during retransmission in the case in which there is an obstacle to transmission of the image file to the second destination node, the image file is not retransmitted from the CDC, and the image file is transferred from the first destination node, which has made a reception report. In other words, for example, the burden on communication resources due to retransmission of the image file on the transmission route from the CDC to the branching node can be reduced. Overall, it becomes possible to improve the efficiency of retransmission when there is an obstacle.

In the case in which retransmission is performed by using the image file in the first destination node, there is no need to hold the image file in the branching node. Therefore, the file storage capacity in the branching node can be suppressed.

Additionally, since the branching node received the reception report from the first destination node and did not receive the reception report from the second destination node, there is very likely to be an obstacle on the route from the branching node to the second destination node.

The image file is retransmitted from the first destination node towards the second destination node in the direction opposite to the direction towards this branching node as seen from the first destination node (in other words, by extending the route from the branching node to the first destination node). Therefore, during retransmission, the image file will not pass through the route from the branching node to the second destination node, in which there is very likely to be an obstacle. For this reason, the likelihood that retransmission will fail again can be lowered.

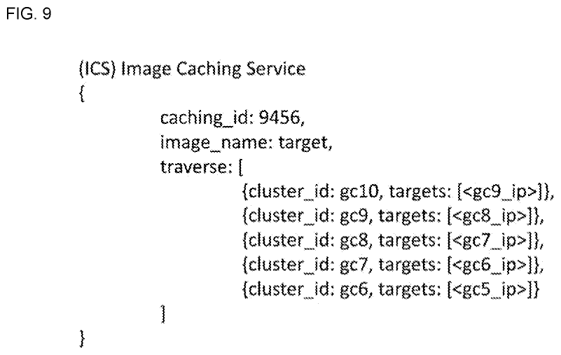

FIG. 9 illustrates an example of a retransmission command transmitted from the branching node. In FIG. 9, the target flags are omitted for convenience of explanation.

This retransmission command is in the same format as the transmission command transmitted together with the image file from the CDC as explained in FIG. 4. In this case, the retransmission command is an Image Caching Service (ICS) as designated in the caching_id (in this example, “9456”) field. The image file to be transmitted is designated by the file name (in this example, “target”) in the image_name field. The file name of the image file may be extracted from the transmission command explained in connection with FIG. 4.

The transmission route for retransmission is designated in the traverse field.

With GC #10 as the communication node (cluster_id), the image file is transmitted to GC #9. Thereafter, the image file is transmitted sequentially, from CG #9 to GC #8, from GC #8 to GC #7, and from GC #7 to GC #6. Finally, the image file is transmitted from GC #6 to GC #5 for the retransmission.

In a manner similar to that explained in FIG. 4, GC #9 to GC #5 can be designated by their respective IP addresses in the retransmission command in FIG. 9 as well.

Such a retransmission command can be prepared in the branching node in the case in which the branching node (Node #1) recognizes the configuration of the ring to which the two destination nodes (Node #10 and Node #5) belong, particularly the arrangement of the communication nodes in the ring and the IP addresses thereof. Alternatively, during retransmission, the branching node may acquire the configuration of the ring from the CDC (particularly the first management apparatus in the CDC). Alternatively, a retransmission command prepared by the CDC (particularly the first management apparatus in the CDC) may be provided to the branching node.

The retransmission command is not limited to an example as illustrated in FIG. 9. Each communication node is assumed to recognize two adjacent communication nodes (particularly the IP addresses of the communication nodes) on the ring. In that case, by referring to the transmission command transmitted by the CDC, the first destination node (e.g., Node #10 in FIG. 8) in which reception has been confirmed recognizes the communication node (Node #11) that transmitted the image file. Thus, the first destination node can transmit the image file for retransmission to the communication node (Node #9), of the two adjacent communication nodes (Node #11 and Node #9), that did not transmit the image file.

Thereafter, a process in which the communication node that received the image file for retransmission transmits the image file for retransmission to the communication node, of the two adjacent communication nodes, that did not transmit the image file, simply needs to be repeated until the second destination node is reached.

Thus, based on the general assumption that each communication node recognizes the two adjacent communication nodes on the ring, each communication node on the ring can generate a retransmission command for transmitting the image file from the first destination node towards the second destination node in the direction opposite to the direction towards the branching node as seen from the first destination node.

Referring again to FIG. 6, regarding the second management apparatus 500 including the retransmission function according to the present embodiment, the reception reporter 551, the destination node recorder 553, and the retransmission command preparer 555 will be explained.

The reception reporter 551, in a destination node, issues a reception report towards the branching node when the image file has been received. In this case, the destination nodes and the branching node on the transmission routes can be specified by the transmission command. Thus, they can be recognized by the functions of the transmission command analyzer 501.

Additionally, issuing a reception report towards the branching node may involve, for example, repeating an operation of transmitting a reception report to an upstream node 20-1/30-1 in each communication node on a transmission route until the branching node is reached.

The reception reporter 551 may transmit a reception report in the case in which the received image file was able to be deployed. That is, the transmission of the image file is made more certain by not issuing the reception report, even if the image file itself has been able to be received, until the reception reporter 551 has confirmed deployment.

The destination node recorder 553 records information for specifying destination nodes so that a branching node can recognize the destination nodes. Information for specifying the destination nodes is, for example, the names or IP addresses of the destination nodes. The destination node recorder 553 may be included in the second management apparatus 500 for communication nodes 20/30 at which the transmission routes are particularly likely to branch.

In the branching node, if a reception report has not been obtained from some of the destination nodes specified by the information recorded in the destination node recorder 553 even after a certain time has elapsed after image file transmission, then a retransmission command is prepared by the retransmission command preparer 555.

The retransmission command preparer 555 may be included in a second management apparatus 500 for a communication node 20/30 at which the transmission routes are particularly likely to branch.

The retransmission command is a command for retransmitting an image file from a first destination node (a destination node in which reception of the image file has been confirmed by the branching node) to a second destination node (a destination node in which reception of the image file has not been confirmed by the branching node). For example, it may be a command as explained by FIG. 9.

The prepared retransmission command is transmitted, by the transmitter/receiver 400 in the branching node, to the first destination node that issued the reception report.

Each communication node on the route for retransmission (referred to as the “retransmission route”) for which the retransmission command has been received analyzes the retransmission command by means of the transmission command analyzer 501. Each communication node on the retransmission route transmits (transfers) the image file along the retransmission route by means of the image file transmission instructor 507 in accordance with the analyzed retransmission command. Each communication node on the retransmission route may transmit (transfer) the retransmission command along the retransmission route by means of the transmission command transmission instructor 505. As a result thereof, it becomes possible to retransmit the image file to the first destination and second destination nodes.

It should be understood that, according to these features further provided in the second management apparatus 500, image file retransmission as mentioned above becomes possible.

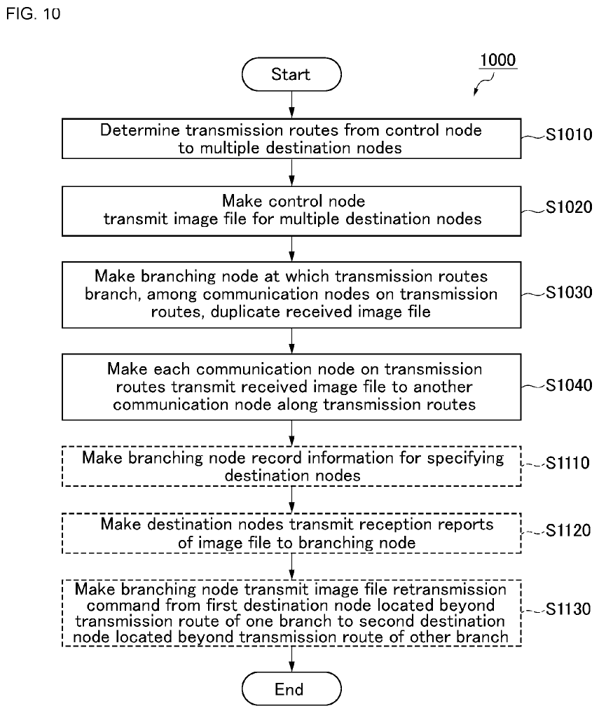

The image file transmission method 1000 to the multiple destination nodes in the communication network system according to the present embodiment will be explained with reference to FIG. 10.

This communication network system has a topology including multiple rings in which the multiple communication nodes are connected in ring form.

The image file transmission method 1000 includes determining transmission routes from the control node to the multiple destination nodes (reference sign S1010). The control node saves image files and may be a CDC. The multiple destination nodes may be multiple GCs. The determined transmission routes may be specified in a transmission command transmitted from the control node to the communication network system.

The image file transmission method 1000 includes causing the control node to transmit the image file for the multiple destination nodes (reference sign S1020). The control node may transmit just a single image file even if there are multiple destination nodes. For example, if multiple destination nodes are located on the same upper-level ring, then the control node may transmit just a single image file. Additionally, the control node may transmit the image file to a communication node adjacent to the control node on the transmission route in the manner of a bucket brigade.

The image file transmission method 1000 includes causing a branching node at which the transmission routes branch, among the communication nodes on the transmission routes, to duplicate the image file received by that branching node (reference sign S1030). The image file duplication by the branching node may be performed in accordance with a transmission command transmitted from the control node to the communication nodes on the transmission routes.

The image file transmission method 1000 includes causing each communication node on the transmission routes to transmit the image file received by that communication node to another communication node along the transmission routes (particularly a communication node that is adjacent on the transmission routes) (reference sign S1040). The image file transmission by the communication nodes may be performed in accordance with a transmission command.

The image file transmission method 1000 may further include causing the branching node to record information for specifying the destination nodes (reference sign S1110). In this case, the information for specifying the destination nodes is, for example, the names or the IP addresses of the destination nodes. Furthermore, such information may be recorded outside the branching node as long as the branching node can identify the destination nodes.

The image file transmission method 1000 may further include causing the destination nodes to transmit image file reception reports to the branching node (reference sign S1120).

The image file transmission method 1000 may further include causing the branching node to transmit a retransmission command for retransmitting the image file from a first destination node located beyond the transmission route of one branch to a second destination node located beyond the transmission route of the other branch (reference sign S1130).

If the branching node has received a reception report from the first destination node, yet has not received a reception report from the second destination node even when a certain time has elapsed after the image file transmission, then a retransmission command may be transmitted from the branching node.

In this case, the retransmission command may make the image file be transmitted towards the second destination node in the direction opposite to the direction towards the branching node as seen from the first destination node.

This image file transmission method 1000 can be executed by the first management apparatus and the second management apparatus explained respectively with reference to FIG. 5 and FIG. 6.

Furthermore, a program for causing the system to execute the above-mentioned image file transmission method 1000 is also included in the present disclosure. Said program may be provided by being recorded on a computer-readable, non-transitory recording medium.

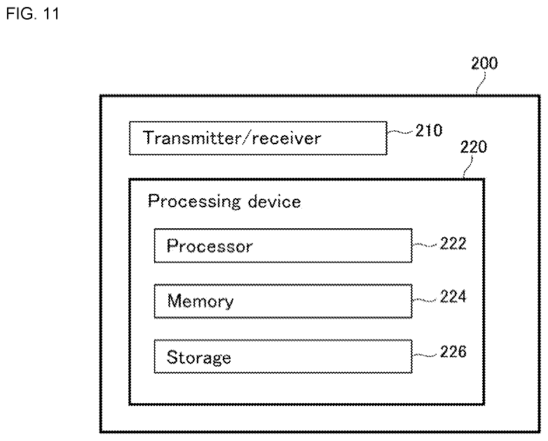

Additionally, the first management apparatus according to the present embodiment can be realized by the apparatus illustrated in the block diagram in FIG. 11. The first management apparatus 200 in FIG. 11 includes a transmitter/receiver 210 and a processing device 220.

The transmitter/receiver 210 transmits and receives data with respect to other communication nodes.

The processing device 220 includes a processor 222 and a memory 224. There may be one or a plurality of the processor 222 and the memory 224. The processing device 220 may further include storage 226. The processing device 220 can operate the transmitter/receiver 210 and can also execute the processes as the first management apparatus by means of the processor 222 and the memory 224.

The first management apparatus may further include features not illustrated in FIG. 11.

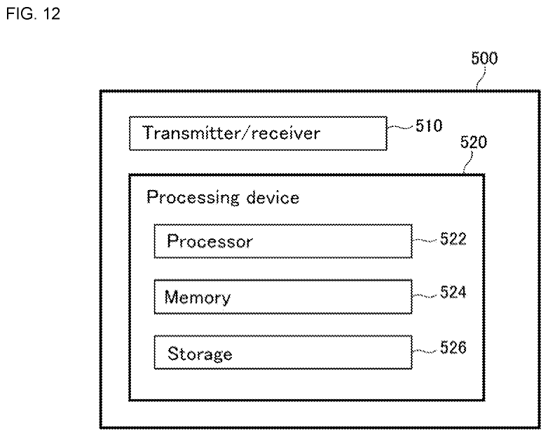

Additionally, the second management apparatus according to the present embodiment can be realized by the apparatus illustrated in the block diagram in FIG. 12. The second management apparatus 500 in FIG. 12 includes a transmitter/receiver 510 and a processing device 520.

The transmitter/receiver 510 transmits and receives data with respect to other communication nodes.

The processing device 520 includes a processor 522 and a memory 524. There may be one or a plurality of the processor 522 and the memory 524. The processing device 520 may further include storage 526. The processing device 520 can operate the transmitter/receiver 510 and can also execute the processes as the second management apparatus by means of the processor 522 and the memory 524.

The second management apparatus may further include features not illustrated in FIG. 12.

The present disclosure is not limited to the embodiment described above, and various modified examples in which constituent elements have been added, deleted, or changed with respect to the configuration described above are included. Additionally, various combinations of the embodiments are possible.

The term “connect” used in the present description refers to a logical connection for communication. For example, “A is connected to B” means that A and B are logically connected so as to be able to communicate. There is no need for A and B to be directly connected in a physical manner, such as with physical cables, and there may be multiple devices or wireless communication between A and B.

Furthermore, the present disclosure includes the embodiments indicated below.

[1] A communication network system including multiple communication nodes and a control node in which an image file is saved,
the communication network system having a topology including multiple rings in which the multiple communication nodes are connected in ring form, the communication network system comprising:
a first management apparatus for the control node, the first management apparatus including one or more first processors, at least one of the one or more first processors executing
   transmitting a transmission command for transmitting an image file to multiple destination nodes among the multiple communication modes, the transmission command specifying transmission routes from the control node to the multiple destination nodes, and
   causing the control node to transmit the image file for the multiple destination nodes; and
a second management apparatus for each communication node, the second management apparatus including one or more second processors, at least one of the one or more second processors executing
   causing a branching node, at which the transmission routes branch, to duplicate the received image file in accordance with the transmission command, and
   causing each communication node on the transmission routes to transmit the received image file to another communication node along the transmission routes in accordance with the transmission command.
      [2] The communication network system as in [1], wherein at least one of the one or more second processors in the second management apparatus further executes
causing the branching node to record information for specifying the destination nodes,
causing the destination nodes to transmit reception reports of the image file to the branching node, and
causing the branching node to transmit a retransmission command for retransmitting the image file from a first destination node located beyond the transmission route of one branch to a second destination node located beyond the transmission route of another branch.
   [3] The communication network system as in [2], wherein the branching node transmits the retransmission command when a reception report has been received from the first destination node, and a reception report has not been received from the second destination node even when a certain time has elapsed after transmission of the image file.
   [4] The communication network system as in [2] or [3], wherein the retransmission command is for transmitting the image file to the second destination node in a direction opposite to a direction towards the branching node as viewed from the first destination node.
   [5] A second management apparatus for each communication node in a communication network system including multiple communication nodes and a control node in which an image file is saved, the communication network system having a topology including multiple rings in which the multiple communication nodes are connected in ring form, the second management apparatus including one or more second processors, and
when the control node transmits the image file for multiple destination nodes among the multiple communication nodes,
at least one of the one or more second processors executes
   causing a branching node to duplicate a received image file in accordance with a transmission command specifying transmission routes from the control node to the multiple destination nodes, the branching node being a node at which the transmission routes branch, among the communication nodes on the transmission routes, and
   causing each communication node on the transmission routes to transmit the received image file to another communication node along the transmission routes in accordance with the transmission command.
      [6] The second management apparatus as in [5], wherein at least one of the one or more second processors further execute
causing the branching node to record information for specifying the destination nodes,
causing the destination nodes to transmit reception reports of the image file to the branching node, and
causing the branching node to transmit a retransmission command for retransmitting the image file from a first destination node located beyond the transmission route of one branch to a second destination node located beyond the transmission route of another branch.
   [7] A method for transmitting an image file from a control node to multiple destination nodes among multiple communication nodes in a communication network system including the multiple communication nodes and the control node in which the image file is saved, the communication network system having a topology including multiple rings in which the multiple communication nodes are connected in ring form, wherein the method includes
determining transmission routes from the control node to the multiple destination nodes,
causing the control node to transmit the image file for the multiple destination nodes,
causing a branching node at which the transmission routes branch, among the communication nodes on the transmission routes, to duplicate the received image file, and
causing each communication node on the transmission routes to transmit the received image file to another communication node along the transmission routes.
   [8] The method as in [7], further including
causing the branching node to record information for specifying the destination nodes,
causing the destination nodes to transmit reception reports of the image file to the branching node, and
causing the branching node to transmit a retransmission command for retransmitting the image file from a first destination node located beyond the transmission route of one branch to a second destination node located beyond the transmission route of another branch.

### REFERENCE SIGNS LIST

1 Communication network system
2 Providing node group
7 Interface
8 Base station
9 Information processing apparatus
10 CDC (control node)
20 RDC
20-1 Upstream RDC
20-2 Downstream RDC
30, 31, 32, 33, 34, 35, 36, 37, 38 GC
30-1 Upstream GC
30-2 Downstream GC
51, 52, 53, 54, 55 Boundary node
61, 62, 63, 64, 65, 66, 67, 68 Boundary node
80 Base station group
100 LCM
200 ICS GM (first management apparatus)
201 Topology acquirer
203 Transmission route determiner
205 Transmission command preparer
207 Transmission command transmission instructor
209 Image file transmission instructor
210 Transmitter/receiver
220 Processing device
222 Processor
224 Memory
226 Storage
300 Container registry (storage)
400 Transmitter/receiver
500 ICS LM (second management apparatus)
501 Transmission command analyzer
503 Image file duplicator
505 Transmission command transmission instructor
507 Image file transmission instructor
510 Transmitter/receiver
520 Processing device
522 Processor
524 Memory
526 Storage
551 Reception reporter
553 Destination node recorder
555 Retransmission command preparer
600 Local registry (storage)
1000 Image file transmission method

1. A communication network system including multiple communication nodes and a control node in which an image file is saved,
the communication network system having a topology including multiple rings in which the multiple communication nodes are connected in ring form, the communication network system comprising:
a first management apparatus for the control node, the first management apparatus including one or more first processors, at least one of the one or more first processors executing
transmitting a transmission command for transmitting an image file to multiple destination nodes among the multiple communication modes, the transmission command specifying transmission routes from the control node to the multiple destination nodes, and
causing the control node to transmit the image file for the multiple destination nodes; and
a second management apparatus for each communication node, the second management apparatus including one or more second processors, at least one of the one or more second processors executing
causing a branching node, at which the transmission routes branch, to duplicate the received image file in accordance with the transmission command, and
causing each communication node on the transmission routes to transmit the received image file to another communication node along the transmission routes in accordance with the transmission command.

2. The communication network system according to claim 1, wherein at least one of the one or more second processors in the second management apparatus further executes
causing the branching node to record information for specifying the destination nodes,
causing the destination nodes to transmit reception reports of the image file to the branching node, and
causing the branching node to transmit a retransmission command for retransmitting the image file from a first destination node located beyond the transmission route of one branch to a second destination node located beyond the transmission route of another branch.

3. The communication network system according to claim 2, wherein the branching node transmits the retransmission command when a reception report has been received from the first destination node, and a reception report has not been received from the second destination node even when a certain time has elapsed after transmission of the image file.

4. The communication network system according to claim 2, wherein the retransmission command is for transmitting the image file to the second destination node in a direction opposite to a direction towards the branching node as viewed from the first destination node.

5. A second management apparatus for each communication node in a communication network system including multiple communication nodes and a control node in which an image file is saved, the communication network system having a topology including multiple rings in which the multiple communication nodes are connected in ring form, the second management apparatus including one or more second processors, and
when the control node transmits the image file for multiple destination nodes among the multiple communication nodes,
at least one of the one or more second processors executes
causing a branching node to duplicate a received image file in accordance with a transmission command specifying transmission routes from the control node to the multiple destination nodes, the branching node being a node at which the transmission routes branch among the communication nodes on the transmission routes, and
causing each communication node on the transmission routes to transmit the received image file to another communication node along the transmission routes in accordance with the transmission command.

6. The second management apparatus according to claim 5, wherein at least one of the one or more second processors further execute
causing the branching node to record information for specifying the destination nodes,
causing the destination nodes to transmit reception reports of the image file to the branching node, and
causing the branching node to transmit a retransmission command for retransmitting the image file from a first destination node located beyond the transmission route of one branch to a second destination node located beyond the transmission route of another branch.

7. A method for transmitting an image file from a control node to multiple destination nodes among multiple communication nodes in a communication network system including the multiple communication nodes and the control node in which the image file is saved, the communication network system having a topology including multiple rings in which the multiple communication nodes are connected in ring form, wherein the method includes
determining transmission routes from the control node to the multiple destination nodes,
causing the control node to transmit the image file for the multiple destination nodes,
causing a branching node at which the transmission routes branch, among the communication nodes on the transmission routes, to duplicate the received image file, and
causing each communication node on the transmission routes to transmit the received image file to another communication node along the transmission routes.

8. The method according to claim 7, further including
causing the branching node to record information for specifying the destination nodes,
causing the destination nodes to transmit reception reports of the image file to the branching node, and
causing the branching node to transmit a retransmission command for retransmitting the image file from a first destination node located beyond the transmission route of one branch to a second destination node located beyond the transmission route of another branch.
